(19) United States
(12) Patent Application Publication
(10) Pub. No.: US 2026/0266243 A1
(43) Pub. Date: Sep. 10, 2026

(54) DAMPING ASSESSMENT BASED ON COMBUSTION SIGNAL ANALYSIS

(71) Applicant: Blue Origin Manufacturing, LLC, Huntsville, AL (US)

(72) Inventors: Scott M. Palmer, Nicholasville, KY (US); Samuel C. Rodkey, McGregor, TX (US)

(21) Appl. No.: 19/074,228

(22) Filed: Mar. 7, 2025

(51) Int. Cl. F02K 9/96; G01H 3/08

(52) U.S. Cl. CPC F02K 9/96; G01H 3/08

(57) ABSTRACT

Systems and methods of determining damping characteristics of a combustion system based on analysis of a combustion signal. One or more sensors, such as pressure transducers, strain gages, flow rate devices, temperature probes, optical measurement devices, microphones, or accelerometers, detects the combustion signal of a firing combustion system, such as a rocket engine having a combustion chamber. A wavelet filter data set, including the data signals from the combustion signal over time for a plurality of frequency bins, is analyzed. The damping coefficient and other characteristics of the combustion system's damping and stability are determined based on analysis of the wavelet filter data set.

### FIELD

This disclosure relates to damping assessment of combustion systems, in particular to assessing the damping characteristics of an actively firing combustion system, such as a rocket engine, using analysis of a combustion signal.

### DESCRIPTION OF THE RELATED TECHNOLOGY

Understanding the damping characteristics of a combustion system, such as a rocket engine having a combustion chamber, can help mitigate the risk of combustion instabilities. Typical analysis of combustion stability and damping characteristics of combustion systems use artificial disturbances. Artificial disturbance of the combustion system uses a bomb of known explosive capability to initiate an overpressure in the system, and then the time for recovery back to normal operation is measured. This method is inefficient because every operating point (e.g. for a given temperature, pressure and propellant mixture ratio) of interest must be examined for a thorough assessment of the system. The process of bomb testing is thus costly and time consuming. The system is typically therefore spot-checked by bombing only specific operating points. Further, repeatability of the effect of this process is not reliable, and some combustion systems simply cannot be bombed due to their design or inherent response to bombing.

Another typical method for assessing damping of combustion systems is to operate the system at all required conditions and to look for spontaneous instability. This typically includes running outside of operational requirements to demonstrate margin in the design.

The existing approaches to damping assessment are inadequate because they merely prove the absence of instability and not every condition can be quantified or explored robustly.

There is therefore a need for improved solutions to damping assessment of combustion systems that overcome these and other drawbacks of existing approaches.

### SUMMARY

The embodiments disclosed herein each have several aspects no single one of which is solely responsible for the disclosure's desirable attributes. Without limiting the scope of this disclosure, its more prominent features will now be briefly discussed. After considering this discussion, and particularly after reading the section entitled “Detailed Description” one will understand how the features of the embodiments described herein provide advantages to assessing damping of combustion systems.

Systems and methods are described herein for determining damping characteristics of a combustion system based on analysis of a combustion signal. Such combustion signal may include pressure signals, noise or background noise (audio signals), or other types of signals resulting from the combustion of the system as detected by a variety of sensor types. One or more sensors, such as pressure transducers or accelerometers or other sensors, detects the combustion signal of a firing combustion system, such as a rocket engine having a combustion chamber. A wavelet or band pass filtering autocorrelation data set, including the results of analysis of the data signals from the combustion signal over time for a plurality of frequency bins, is analyzed. The damping coefficient and other characteristics of the combustion system's damping and stability are determined based on analysis of the wavelet or band pass filter autocorrelation data set.

In one aspect, a method of determining damping characteristics of a combustion system is described. The method comprises firing the combustion system, and detecting, with one or more sensors, a combustion signal from the firing combustion system to generate a plurality of data signals. The method further comprises, for each of a respective frequency bin of a plurality of frequency bins: filtering the plurality of data signals for a frequency within the respective frequency bin, autocorrelating a portion of the filtered plurality of data signals, and estimating a respective damping coefficient for the respective frequency bin based on curve fitting of the autocorrelation. The method further comprises analyzing a wavelet filter data set to determine damping characteristics of the firing combustion system, the wavelet filter data set comprising estimated damping coefficients for the plurality of frequency bins over time.

Various embodiments of the above and other aspects may be implemented. The curve fitting may comprise solving a generalized characteristic differential equation. Determining damping characteristics may comprise comparing the estimated damping coefficients over time for a range of frequencies that comprises the plurality of frequency bins. The plurality of frequency bins may comprise one or more frequencies corresponding to an instability of the firing combustion system. The method may further comprise detecting the plurality of data signals during a transient operation of the combustion system. The transient operation may comprise startup, throttling up, throttling down, mixture ratio increase, mixture ratio decrease, feed system propellant temperature increase, feed system propellant temperature decrease, or shutdown of the combustion system. The portion of the filtered plurality of data signals may be a first portion of the filtered data signals, and the method may further comprise autocorrelating a second portion of the filtered data signals, and estimating a respective damping coefficient for the respective frequency bin based on curve fitting of the autocorrelation of the second portion. The data signals may comprise pressure data signals, vibration data signals, strain data signals, flow rate data signals, temperature data signals, optical data signals, or acoustic data signals. The one or more sensors may comprise one or more transducers or one or more accelerometers. The combustion system may be a rocket engine comprising a combustion chamber, and the method may further comprise adjusting operation of the rocket engine based on the determined damping characteristics.

In another aspect, another method of determining damping characteristics of a combustion system is described. The method comprises firing the combustion system, detecting a plurality of data signals indicative of a combustion signal from the firing combustion system, generating a wavelet filter data set for the firing combustion system based on analysis of the plurality of data signals, the wavelet filter data set comprising estimated damping coefficients for a plurality of frequency bins over time, and analyzing the wavelet filter data set to determine damping characteristics of the firing combustion system.

Various embodiments of the above and other aspects may be implemented. Analysis of the plurality of data signals may comprise autocorrelation of the plurality of data signals. Generating the wavelet filter data set may further comprise filtering the plurality of data signals for a frequency within a respective frequency bin of the plurality of frequency bins, autocorrelating the filtered plurality of data signals, and estimating a respective damping coefficient for the respective frequency bin based on the autocorrelation. The plurality of frequency bins may comprise one or more frequencies corresponding to an instability of the firing combustion system. The method may further comprise detecting the plurality of data signals during startup, throttling up, throttling down, mixture ratio increase, mixture ratio decrease, feed system propellant temperature increase, feed system propellant temperature decrease, or shutdown of the combustion system. The combustion system may be a rocket engine comprising a combustion chamber, and the method may further comprise adjusting operation of the rocket engine based on the determined damping characteristics.

In another aspect, a non-transitory computer readable medium is described comprising instructions that, when executed by a computing processor, causes a method for determining damping characteristics of an actively firing combustion system. The method comprises receiving a plurality of data signals of a combustion signal from the firing combustion system, determining a plurality of estimated damping coefficients over time for a plurality of frequency bins based on analysis of the plurality of data signals of the combustion signal of the firing combustion system, and determining damping characteristics of the firing combustion system based on analyzing the plurality of estimated damping coefficients.

Various embodiments of the above and other aspects may be implemented. Analysis of the plurality of data signals of the combustion signal of the firing combustion system may comprise autocorrelation of the plurality of data signals of the combustion signal. The data signals may comprise pressure data signals, vibration data signals, strain data signals, flow rate data signals, temperature data signals, optical data signals, or acoustic data signals. The combustion system may be a rocket engine comprising a combustion chamber, and the method may further comprise adjusting operation of the rocket engine based on the determined damping characteristics.

### BRIEF DESCRIPTION OF THE DRAWINGS

This disclosure is described herein with reference to drawings of certain embodiments, which are intended to illustrate, but not to limit, the present disclosure. It is to be understood that the accompanying drawings, which are incorporated in and constitute a part of this specification, are for the purpose of illustrating concepts disclosed herein and may not be to scale.

FIG. 1A is a schematic of an embodiment of a rocket engine on a test firing stand having a combustion system and a system for assessing damping of the combustion system based on analysis of combustion signal.

FIG. 1B is a schematic of an embodiment of a rocket having a combustion system and a system for assessing damping of the combustion system based on analysis of combustion signal.

FIG. 2 is a data plot showing example sets of raw noise data signals (e.g., pressure or acoustic data signals) over time for a low-power unstable firing and a high-power stable firing of a combustion system.

FIGS. 3A-3D show example data plots used in analysis of the data signals from the plot in FIG. 2, including respectively a portion of the data signals over time (FIG. 3A), filtering of that portion of data for a frequency of interest using wavelet or band pass filter (FIG. 3B), an autocorrelation of part of the filtered portion of data (FIG. 3C), and an example second-order response for curve fitting the autocorrelation and determining an estimated linear damping coefficient for the frequency of interest (FIG. 3D).

FIGS. 4A and 4B depict example wavelet filter data sets that plot the estimated linear damping coefficient over time for a plurality of frequency bins for, respectively, the low-power unstable firing (FIG. 4A) and the high-power stable firing of the combustion system (FIG. 4B).

FIGS. 4C-4F are example data plots with linear regressions of damping coefficient over time for respective frequency bins from the wavelet filter data set of FIGS. 4A and 4B.

FIG. 5 is a block diagram of an embodiment of a system having a combustion system and that may use any of the methods described herein for damping assessment of the combustion system.

FIGS. 6A-7 are flow charts showing embodiments of methods for determining damping characteristics of a combustion system based on analysis of the combustion signal and that may be performed by any of the systems described herein.

### DETAILED DESCRIPTION OF THE PREFERRED EMBODIMENT

In the following detailed description, reference is made to the accompanying drawings. In the drawings, similar symbols typically identify similar components, unless context dictates otherwise. Thus, in some embodiments, part numbers may be used for similar components in multiple figures, or part numbers may vary from figure to figure. Further, the illustrative embodiments described herein are not meant to be limiting. Other embodiments may be utilized, and other changes may be made, without departing from the spirit or scope of the disclosure presented. It will be readily understood that the aspects of the present disclosure described herein and illustrated in the figures can be arranged, substituted, combined, and designed in a wide variety of different configurations by a person of ordinary skill in the art, all of which are made part of this disclosure.

Reference in the specification to “one embodiment,” “an embodiment”, or “in some embodiments” means that a particular feature, structure, or characteristic described in connection with the embodiment is included in at least one embodiment of the disclosure. Moreover, the appearance of these or similar phrases throughout the specification does not necessarily mean that these phrases all refer to the same embodiment, nor are separate or alternative embodiments necessarily mutually exclusive. Various features are described herein which may be exhibited by some embodiments and not by others. Similarly, various requirements are described which may be requirements for some embodiments but may not be requirements for other embodiments.

Systems and methods are described herein for analysis of combustion systems, such as rocket engine combustion systems, to determine the system damping characteristics. The combustion signal may be analyzed to empirically measure the damping coefficient. Such combustion signal may include pressure signals or background noise of the system or other types of signals detected by a variety of sensor types. Sensors such as dynamic pressure transducers and accelerometers or other sensors may be used to detect the signals and generate data signals for analysis. The analysis may be based on the principles of linear dynamic systems to provide a direct measurement of an actively firing combustion system. The data may be analyzed using a wavelet filter data set, such as a plot, of estimated linear damping coefficients over time for each of a respective frequency bin to determine damping characteristics of the firing combustion system.

The analysis of steady operation and the combustion signal in the combustion system according to the present disclosure provides a wealth of information. The analysis methods described herein provide a way to fully quantify, with a high degree of resolution, the damping characteristics of the system instantaneously at all operating points, including highly dynamic events like startup and shutdown transients. The analysis methods do not require the combustion system to go unstable to prove a threshold, which can damage the combustion system under test. Furthermore, the methods may be used during normal operation where linear system assumptions for combustion stability analysis are relevant.

The systems and methods according to the present disclosure have many advantages and benefits. For example, the combustion system may be measured for damping characteristics both temporally and in frequency and related back to fundamental instability modes of the combustion system and the engine system. Further, objective measurements may be made to compare and contrast design features and operating conditions of the combustion system. Also, it is feasible to implement the approach in real-time, providing monitoring and assessment of system damping as an actionable signal in testing and flight. This would allow, for example, a system to be shut down to save the hardware from catastrophic failure or return to safe operating when a damping condition threshold is exceeded or anticipated.

These are merely some example features and advantages of the systems and methods of the present disclosure. Further details of example combustion systems and analysis systems and methods for damping assessment are described herein.

### A. Example Combustion Systems

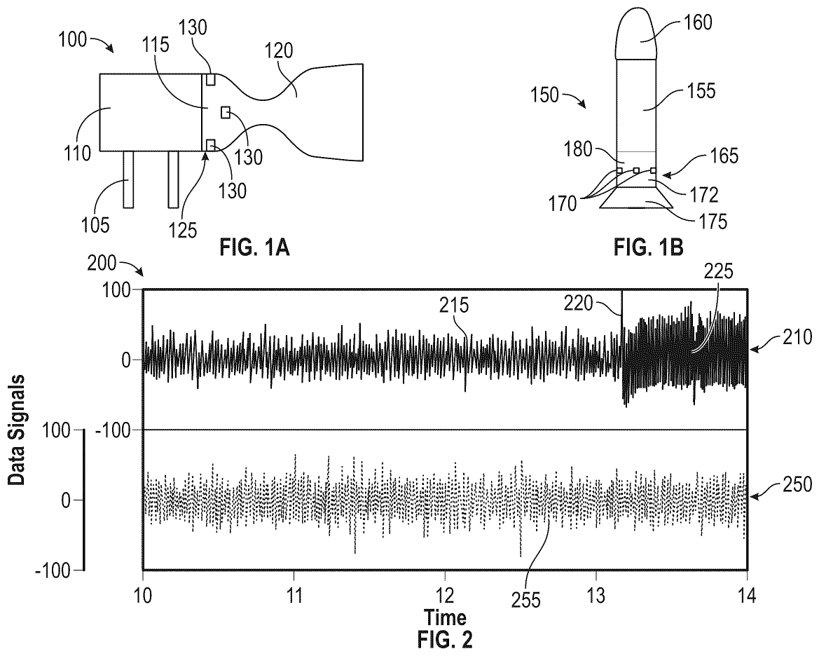

FIG. 1A is a schematic of an embodiment of a rocket engine 100 on a test firing stand 105 having a combustion system 110 and a control system 125 for assessing damping of the combustion system 110 based on analysis of the combustion signal.

The combustion system 110 may include a combustion chamber 115 and a nozzle 120. The combustion system 110 may be a liquid rocket engine or a solid rocket engine. The rocket engine may be for a booster, a second stage rocket, or a spacecraft. A fuel and an oxidizer may combust in the combustion chamber 115 to emit exhaust from the nozzle 120 to produce thrust.

The control system 125 may be configured to analyze the combustion produced by the combustion system 110 to determine damping characteristics of the combustion system 110. The control system 125 may include various electronics and components. The control system 125 may include one or more sensors 130. The sensors 130 may detect the combustion signal of the combustion. The sensors 130 or other components of the control system 125 may generate data signals related to the detected the combustion signal. The sensors 130 or other component may transmit the data signals for analysis, for example to one or more processors of the control system 125 and/or to another vehicle or to a ground station. The sensors 130 may include one or more dynamic instrumentation, such as pressure transducers, strain gages, microphones, optical lasers, high speed cameras, radiograph, temperature probes, flow rate measurement devices, or one or more accelerometers. The sensors 130 may include any device that can make a dynamic measurement of the system allowing for accurate assessment of frequencies of interest.

The rocket engine 100 may be at any operating point of firing the combustion system 110, such as startup, steady state, throttle up, throttle down, mixture ratio increase, mixture ratio decrease, feed system propellant temperature increase, feed system propellant temperature decrease, or shut down. The systems and methods described herein for damping assessment may be operated or performed during firing at any operating point, including transient operating points.

Any of the systems and methods shown in and described with respect to FIGS. 2-7 herein may be used with the rocket engine 100. Further, the rocket engine 100 is merely one example system that may include a combustion system for analysis according to the methods of the present disclosure. Another example system is shown in and described with respect to FIG. 1B.

FIG. 1B is a schematic of an embodiment of a rocket 150 having a combustion system 180 and a control system 165 for assessing damping of the combustion system 180 based on analysis of combustion signal. The rocket 150 may include a body 155, for example an outer cylindrical structure storing propellant tanks, and a nose cap 160, for example a fairing covering a payload. The rocket 150 may be a liquid or solid rocket. The rocket 150 may be a stage for a launch vehicle having multiple stages. The rocket 150 may be configured to launch a payload into orbit.

The combustion system 180 may be an engine of the rocket 150 including a combustion chamber 172 and nozzle 175. The combustion system 180 may cause propellants to flow into and combust within the combustion chamber 172 to emit the exhaust out of the nozzle 175 and produce thrust. The rocket 150 may be at any stage of the mission where the combustion system 180 is firing, including launch, boost, orbital insertion, reentry, or landing.

Any of the systems and methods shown in and described with respect to FIGS. 2-7 herein may be used with the rocket 150. Further, the rocket 150 is merely one other example system that may include a combustion system for analysis according to the methods of the present disclosure. Other example systems and variations thereof may use the systems and methods described herein. Operation of the rocket 150 engine with combustion chamber or other combustion systems may be adjusted based on the determined damping characteristics using the analyses described herein.

### B. Example Combustion Noise Data Signals

FIG. 2 is a data plot 200 showing an example low power data set 210 and high-power data set 250 for data signals (e.g., pressure or acoustic data signals) generated over time. The horizontal axis is time, for example in seconds, and the vertical axes are data signals, for example amplitude of a pressure or acoustic signal. The same horizontal axis applies to both data sets 210, 250, while each data set 210, 250 has its own vertical axis as shown. The horizontal axis begins at 10 seconds and ends at 14 seconds. The two vertical axes extend from about 100 to −100 (e.g., current generated by the sensors or as determined by an analog-to-digital-converter). This is just one sample range for the variables and other ranges of data may be used.

The data sets 210, 250 may result from detecting raw data associated with the combustion signal, for example from a rocket or rocket engine and using any of the sensors or other components described herein. The low-power data set 210 (upper part of figure) is a noise signal generated from a low-power firing of the combustion system that goes unstable. The high-power data set 250 (lower part of figure) is a noise signal generated from a high-power firing (e.g., relatively higher thrust) of the combustion system that maintains stability. The data sets 210, 250 are thus generated from the same combustion system and may be from any of the combustion systems described herein.

The data sets 210, 250 have, respectively, initial stable data portions 215, 255 indicating a period of stable combustion. The low-power data set 210 is stable from 10 seconds to about 13.2 seconds. The high-power data set 250 is stable over the entire range shown, from 10 seconds to 14 seconds.

As shown, the low-power data set 210 goes unstable at a transition data portion 220 around 13.2 seconds and continues to be unstable along an unstable data portion 225 up to 14 seconds. In the low-power data set 210, there is no clear indication prior to the transition data portion 220 that instability is imminent. Over the same time period, for the high-power data set 250, the initial stable data portion 255 continues from 10 seconds all the way to 14 seconds.

“Stable combustion” as used herein has its usual and customary general meaning of a combustion process that does not cause damage or inability of the combustor to perform its function or harm mating components. Specifically in the context of determining linear damping, combustion that is free of resonant operation for a given combustor's natural acoustic modes, such as tangential, longitudinal, or combination tangential-longitudinal, or multiples of these acoustic modes, as operation in these resonant modes typically causes excessive heating damage to the combustor or failure of coupled components due to vibration resonance. Increasing linear damping of the combustor corresponds with reduction of system excitation, due to the energy release forcing function and therefore an increased margin of the system to operate safely without acoustic resonance. In FIG. 2, data set 210 shows a transition from stable combustion 215 to unstable combustion 225 at 220, where 225 has a dominant frequency of first tangential acoustic mode of the combustor and exhibits higher combustor wall heat transfer, as well as excessive system vibration. Acoustic natural modes of a combustor may be a function of the type of combustion product fluid, the mixture ratio of incoming propellants, dimensions of the combustor, the temperature of incoming propellants, the temperature of the combustion, the pressure of the combustion, acoustics of the feed system and acoustics of a sonic throat. As many of these dependencies change—with throttling the combustor, or transient startup, shutdown, throttle transitions, mixture ratio transitions, and feed system propellant temperature transitions-stable combustion requires sufficient damping at all these conditions.

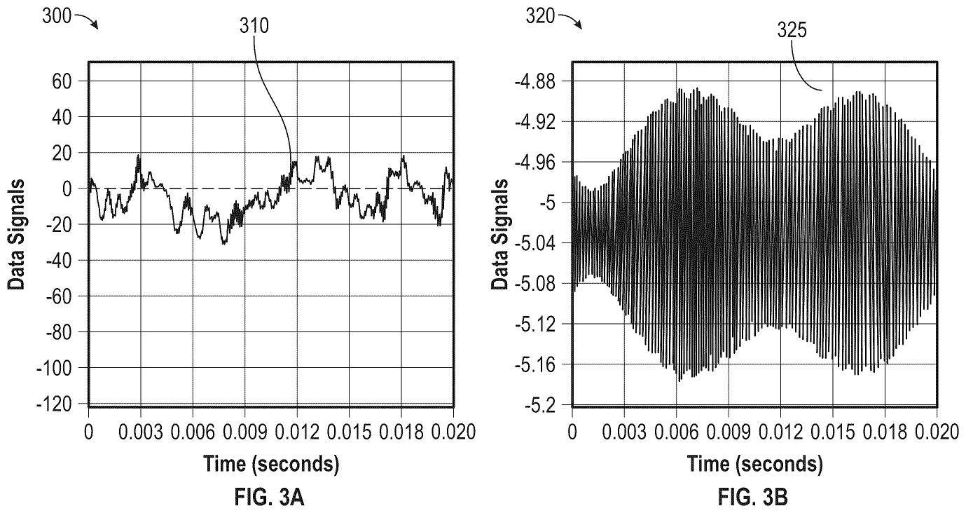

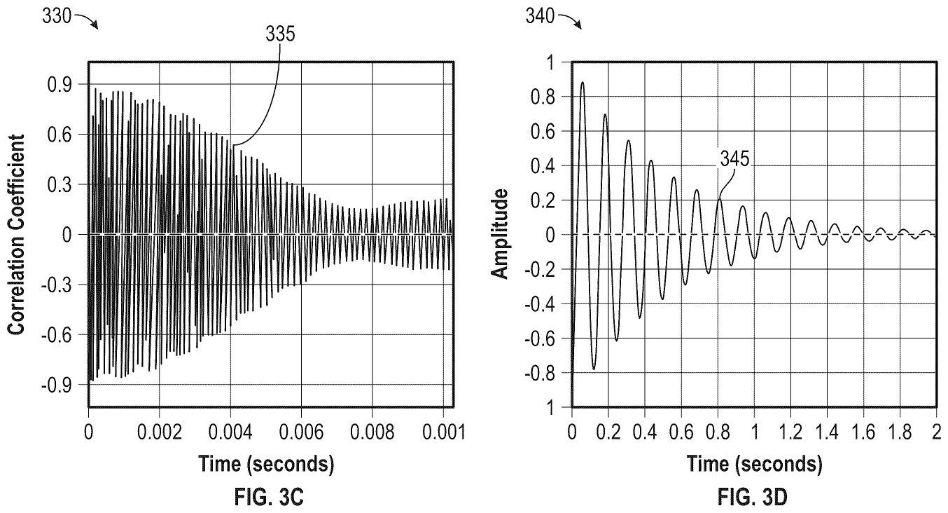

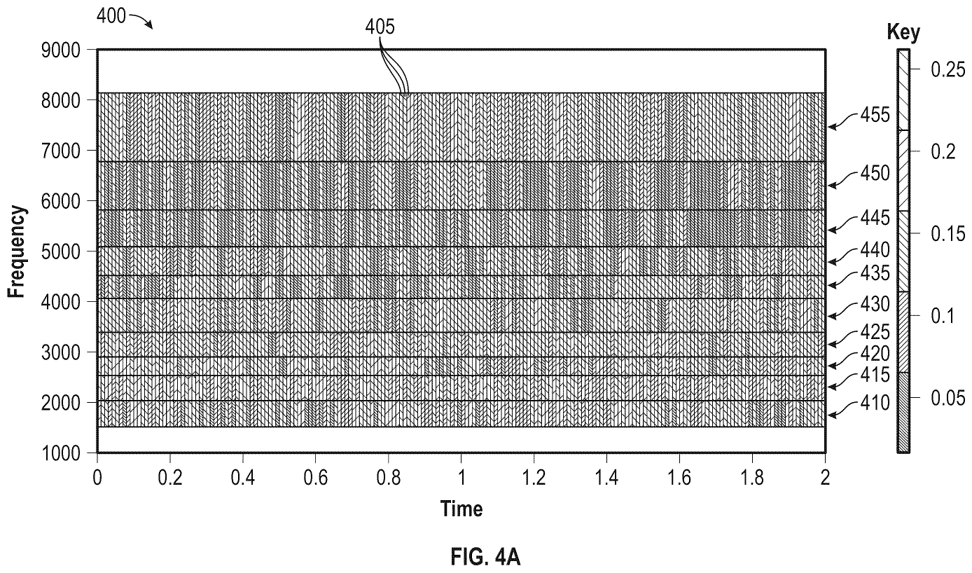

The systems, devices, and methods according to the present disclosure allow for detecting and/or anticipating an instability of the combustion system, based on analysis of the combustion signal to assess damping. Example systems, devices, and methods for particular embodiments and sample data are shown in and described with respect to FIGS. 3A-7.

### C. Example Damping Coefficient Calculations

FIGS. 3A-3D show example data plots that may be used in analysis of the data signals from the low power data set 210 shown in FIG. 2 to assess the damping characteristics of the combustion system that generated the low-power data set 210. Other data sets may be used. This is merely one example for illustrative purposes.

FIG. 3A is a data portion plot 300 showing a portion of data signals 310 taken from the low power data set 210 over a smaller time period than what is shown in FIG. 2. The data portion plot 300 may be a subset of the low-power data set 210. The horizontal axis is time (e.g., in seconds) and the vertical axis is the data signal (e.g., amplitude). The data signals 310 may be from an initial time of zero to about 0.020 seconds and range in value from about −35 to 20.

FIG. 3B is an example filtered data plot 320 showing resulting filtered data 325 from filtering the data signals 310 of the data portion plot 300 for a frequency of interest. The horizontal axis is time and extends from zero to about 0.020 seconds. The vertical axis is the filtered data signal. For example, the control system 125 may provide the data signals 310 as an input to a band pass filter that corresponds to a particular frequency range. The band pass filter may remove portions of the data signals 310 that fall outside the frequency range. Other filtering techniques may be used that remove unwanted frequencies from the data signals 310, such as one or more notch filters, a combination of one or more low-pass filters and one or more high-pass filters (e.g., where the data signals 310 may be provided as an input to each filter sequentially until the desired frequency range remains in the filtered portion of the data signals 310), and/or the like.

FIG. 3C is an example autocorrelation plot 330 resulting from autocorrelation of an initial part of the filtered data 325 from FIG. 3C. The horizontal axis is time from zero seconds to about 0.001 seconds. The vertical axis is the correlation coefficient ranging from −1 to 1. “Autocorrelation” as used herein has its usual and customary meaning and includes, without limitation, correlating a data signal from a series of the data signal with a delayed copy of itself as a function of time. Autocorrelation may refer to the similarity between observations of the given data signal as a function of the time lag between similar instances.

The autocorrelation plot 330 is analyzed for curve fitting. In this embodiment, the autocorrelation plot 330 response is a measure of a second order system with damping and natural frequency. The first part of the autocorrelation plot 330 nearest zero can be fitted to the homogeneous solution of the characteristic equation where linear second order system assumption is reasonable, and then the damping coefficient and natural frequency can be determined. Since the natural frequency of this filtered point is just the target filtered frequency, the coefficient of interest in this fitting process is the linear damping coefficient or the measure of rate of decay of oscillations as exemplified in the curve fit for the data set 345. The fitting process can use a least-square method, weighted least-square method using weighting factors to control error minimization of fit, robust least-square method for treatment of outlier data points, or nonlinear least-square method to obtain better fit for data with nonlinear effects.

FIG. 3D is an example second-order response plot 340 showing the data set 345. The horizontal axis is time in seconds and the vertical axis is the response amplitude normalized to be between −1 and 1. The response plot 340 may be used for curve fitting the autocorrelation plot 330 and determining an estimated linear damping coefficient for the frequency of interest. For stable combustion, the system is either over-damped or critically-damped.

A variety of different response plots may be used. As shown, the response plot 340 may be a generalized forced response of a second-order system to non-zero initial conditions. A generalized characteristic differential equation may be used to describe the response plot 340, as follows:

$$\ddot{y} + 2 ζ {ω}_{n} \dot{y} + {ω}_{n} y = f ( t ) \qquad ( 1 )$$

In differential equation (1): y is the system output, ζ is the damping coefficient, ωₙ is the natural frequency, and ƒ(t) is some forcing function of time (t). The differential equation (1) may be solved for the homogenous solution y(t), resulting in the following:

$$y ( t ) = \frac{{y}_{o}}{\sqrt{1 - {ζ}^{2}}} {e}^{( - ζ {ω}_{n} t )} cos ( \sqrt{1 - {ζ}^{2}} {ω}_{n} t ) \qquad ( 2 )$$

In equation (2), the variables are the same as in equation (1) and yₒ is the initial condition. A frequency of interest ωₙ may be identified and the initial condition yₒ and system output y may be detected, and thus the equation (2) may be solved for the damping coefficient ζ corresponding to that particular frequency of interest.

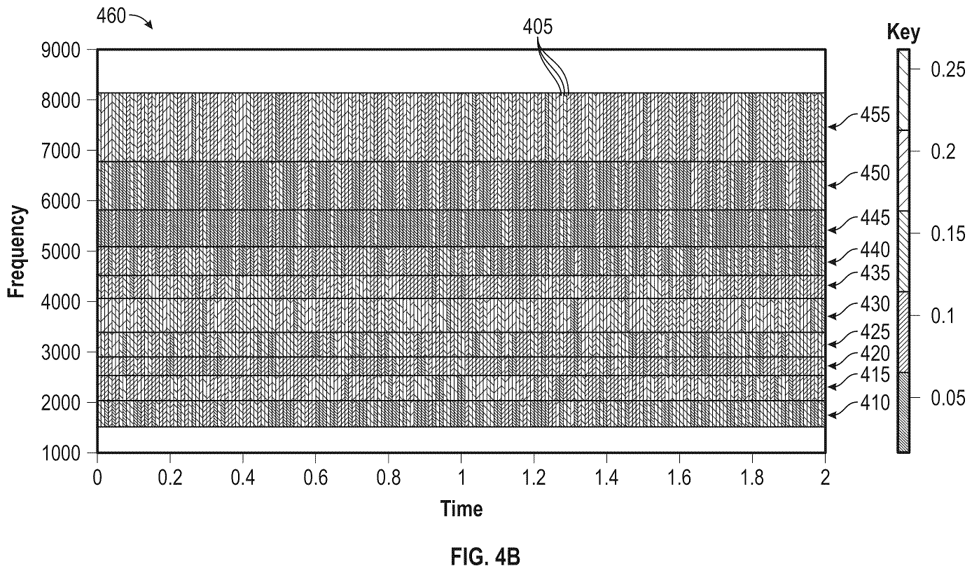

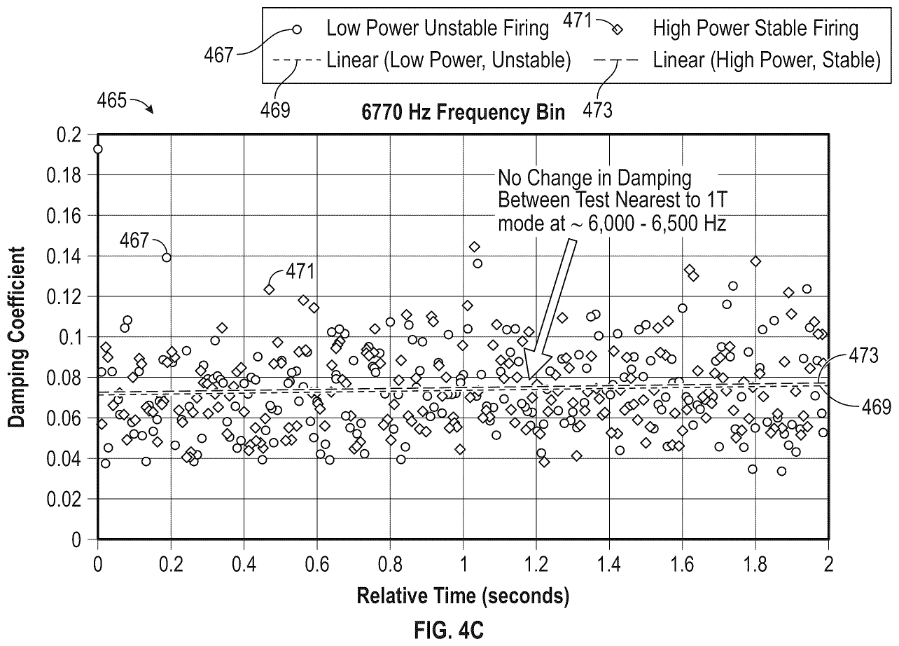

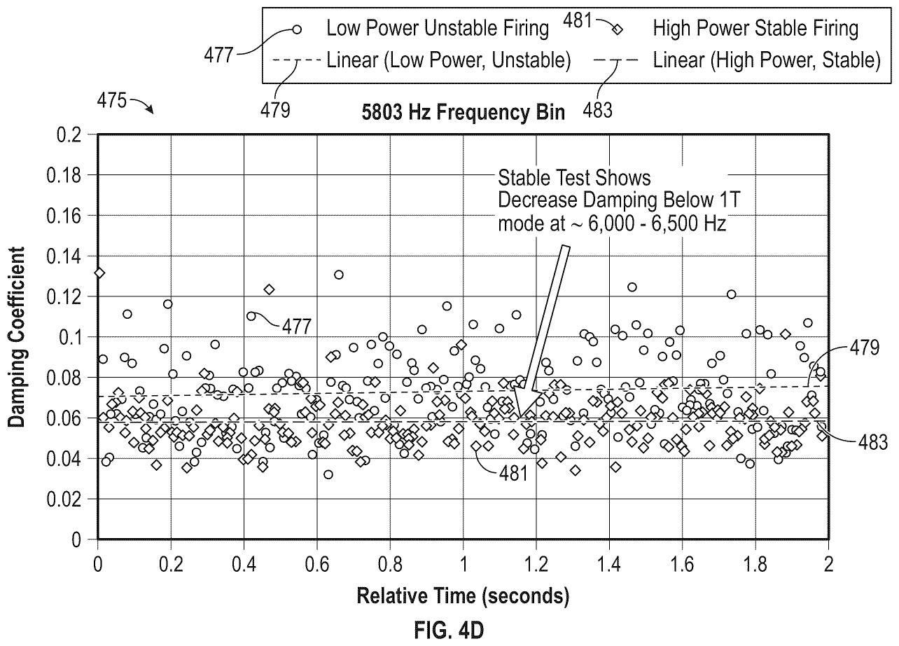

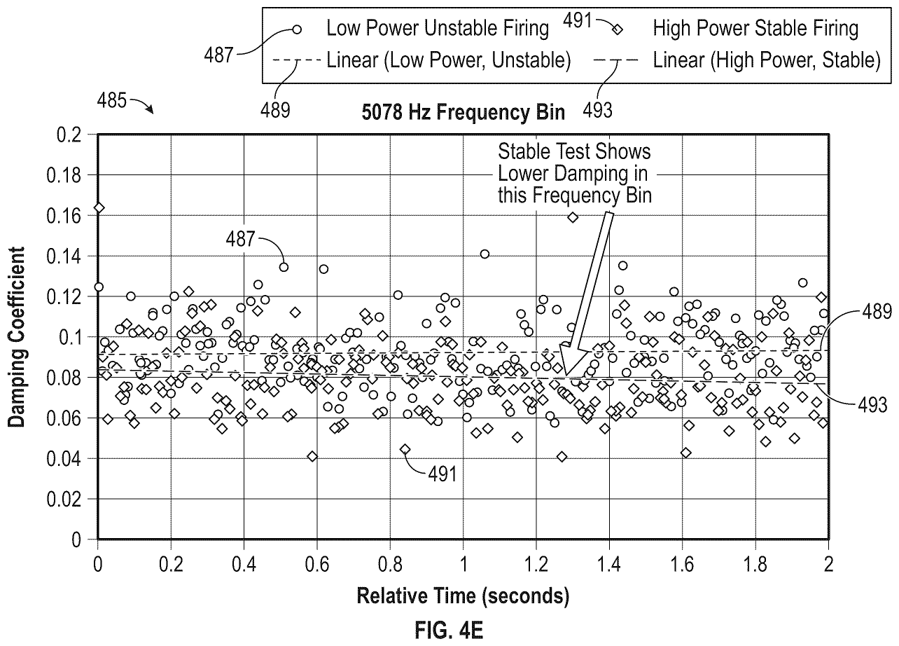

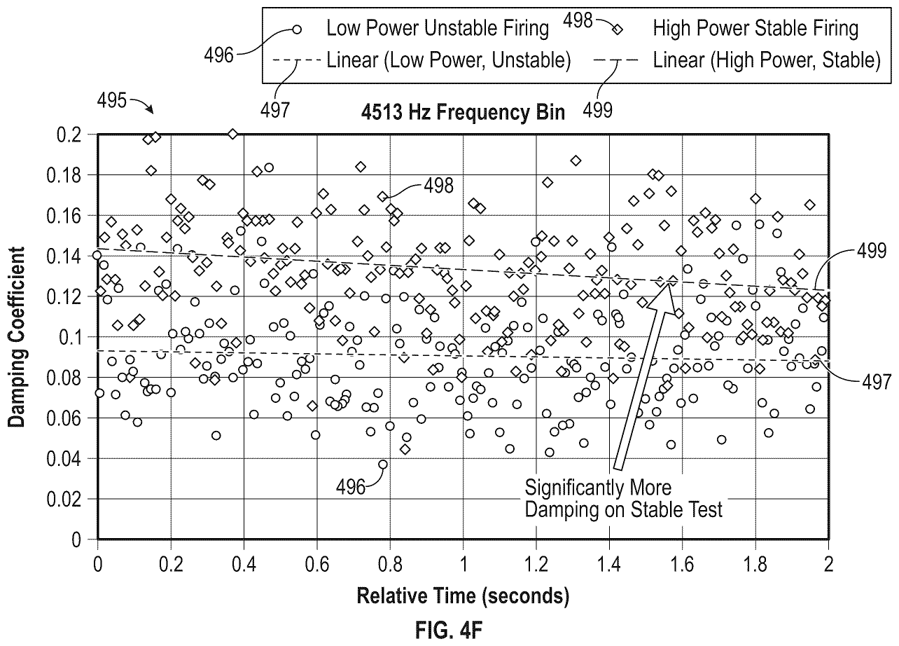

The damping coefficient ζ may be found for multiple frequencies of interest, including frequencies that are representative of the entire range of expected frequencies in the combustion signal. Thus, the analysis shown in and described with respect to FIGS. 3A-3D may be repeated for each of a multitude of representative frequencies. The damping coefficients for each representative frequency may be used to generate for each a wavelet data filter point and assessed for damping and stability characteristics of the combustion system, as further discussed with respect to FIGS. 4A-4F.

The wavelet filtering technique described herein may be a type of band pass filtering technique. In some embodiments, the wavelet filtering technique may be similar to the operation described with respect to FIG. 3B. For example, the plot in FIG. 3B may be a band pass filter of the data in FIG. 3A at a narrow range of frequency. If the frequency of interest is 1,000 Hz, then a band pass filter of 950 Hz to 1050 Hz could be applied to the time series data in FIG. 3A to result in the time series data in FIG. 3B. In this example, a wavelet with target frequency of 1,000 Hz may be defined to produce a similar FIG. 3B plot, but using wavelets in place of the conventional band pass filter. At that point, either the band pass filter or wavelet time series, similar to FIG. 3B, can be autocorrelated, as done in FIG. 3C, and then a curve fit of a linear dynamic system may be performed on the data of FIG. 3C, producing the curve fit of FIG. 3D. Finally, the damping coefficient of the linear dynamic system may be extracted as a result for that point. This is merely one example for the sake of illustration of the wavelet filtering technique described herein.

The wavelet filtering techniques described herein have several advantages over conventional band pass and other traditional filtering techniques, including but not limited to: vastly improving the resolution and computation efficiency; achieving a better balance between reducing noise and preserving features than traditional filtering methods; more powerful for denoising for image enhancement and easier to use than conventional smoothing methods; low computational complexity; more robust to outliers; certain processes may be examined at different temporal scales without the edge effects of traditional band pass filters; more reliable estimates of correlation between long memory time series; and wavelet convolution retains the temporal resolution of the data. Band pass filters may be useful for isolating a specific signal or removing unwanted noise from a circuit. However, no band pass filter is ideal because they don't completely attenuate all frequencies outside the desired range.

### D. Example Damping Assessment Via Wavelet Analysis

FIGS. 4A and 4B depict example wavelet filter data sets 400, 460 respectively that show the estimated linear damping coefficient for various frequencies (vertical axes) over time (horizontal axes). The wavelet filter data set 400 is for the low-power unstable firing of the combustion system (corresponding to the low-power data set 210 of FIG. 2). The wavelet filter data set 460 is for the high-power stable firing of the combustion system (corresponding to the high-power data set 250 of FIG. 2). The frequencies correspond to the natural frequencies of interest from the wavelet filtering and range from about 1,500 Hz to about 8,000 Hz. The time for wavelet filter data set 400 is the two seconds immediately preceding an instability for the low-power level data set 215 just before the event at the transition data portion 220. The time for wavelet filter data set 460 is a similar two second window of operation for high-power data set 250. These are merely chosen for illustration, and other values or ranges for the frequencies and time may be selected.

The wavelet filter data sets 400, 460 are each divided into a plurality of bins 405 (for clarity, only some of the bins 405 are labelled in FIGS. 4A and 4B). The horizontal width of each bin 405 corresponds to a given length of time, which as shown may be a smaller time span of the overall time span of the horizontal axis. The length of time for each bin 405 may be uniform as shown. In some embodiments, the length of time for each bin 405 may not be uniform. As shown, there may be about 100 bins per second, or each bin may have a width corresponding to a time span of 0.01 seconds. In some embodiments, there may be from 10 to 1,000 bins per second. There may be greater than 10, greater than 20, greater than 30, greater than 40, greater than 50, greater than 60, greater than 70, greater than 80, greater than 90, greater than 100, greater than 200, greater than 300, greater than 400, greater than 500, greater than 750, or greater than 1,000 bins per second. Maximum bins per second can be higher based on desired time resolution dampening coefficient and within limits of sample rate of original combustion signal.

The vertical height of each bin 405 corresponds to a given frequency range, which as shown may be a smaller frequency range of the overall frequency range of the vertical axis. The frequency range of each bin 405 may not be uniform, as shown. In some embodiments, the frequency range for each bin 405 may be uniform. The frequency range (height) of the bins 405 may be from 10 Hz to 2,000 Hz, or from 100 Hz to 1,000 Hz. The frequency range may be dependent on the sample rate of the original combustion signal. The bins 405 may be arranged in rows. Each row may have a uniform frequency range. There may be from 2 to 100 rows, from 3 to 50 rows, from 4 to 25 rows, or from 5 to 15 rows. An upper limit of number of rows may only be limited by the sample rate of the original combustion signal, where the higher the sample rate the more rows that may be determined from the wavelet filtering process. As shown, there may be 10 rows. There may be a first row 410, a second row 415, a third row 420, a fourth row 425, a fifth row 430, a sixth row 435, a seventh row 440, an eighth row 445, a ninth row 450 and a tenth row 455. Each of these rows may have, respectively, a frequency range (height) of about 500 Hz, 700 Hz, 300 Hz, 400 Hz, 600 Hz, 400 Hz, 600 Hz, 800 Hz, 1,000 Hz, and 1,300 Hz. There may be fewer or more than ten rows.

Each bin 405 has a corresponding damping coefficient, as shown by the key. The damping coefficient is determined as described above for a frequency of interest that falls within the frequency range of each bin 405. Thus, the damping coefficient for that frequency of interest is used as an estimate for the damping coefficient for all frequencies within that same bin 405. The damping coefficient is determined for a frequency of interest that is in the middle of the frequency range (height) of the bin 405, and represents the damping coefficient for the entire bin frequency range.

The wavelet filter data sets 400, 460 can be analyzed to determine damping characteristics of the combustion system for the respective firing levels. Changes in the damping coefficient over time within a bin 405 and/or row may be analyzed. Changes in the damping coefficient based on frequency level may be analyzed. For example, for the wavelet filter data set 400 for the low-power unstable firing, the damping coefficient is low at the first tangential mode of the combustion system around 6,000-6,500 Hz corresponding to the ninth row 450. For the wavelet filter data set 460 for the high-power stable firing, the lowest damping coefficient has shifted down, relative to the wavelet filter data set 400, around 5,000-6,000 Hz corresponding to the eighth row 450. As further example, the damping coefficient in the fifth row 430 is higher in the wavelet filter data set 460 for the high-power stable firing relative to the wavelet filter data set 400 for the low-power unstable firing.

In some embodiments, the control system 125 may use artificial intelligence (e.g., machine learning) to analyze damping characteristics and predict current or future rocket engine instability. In particular, the control system 125 and/or another system external to the rocket engine 100 may train one or more machine learning models to predict situations in which the rocket engine 100 combustion is, or is about to become, unstable using a training data set. A trained machine learning model may be associated with a particular frequency range (e.g., a single row of bins 405 or multiple rows of bins 405) and/or a particular time period (e.g., a single column of bins 405 or multiple columns of bins 405).

A machine learning model may be trained to be associated with a frequency range and a time period corresponding to a single bin 405, and the training data set may include one or more training data items. Each training data item may include a damping coefficient value for the frequency range and time period, and be labeled with an indication of whether the damping coefficient value represents a stable rocket engine 100 combustion, an unstable rocket engine 100 combustion, or a rocket engine 100 combustion that may become unstable in the future (optionally with an indication of the time period by which the rocket engine 100 may become unstable).

A machine learning model may be trained to be associated with a frequency range and a time period corresponding to a single row of bins 405. The training data set may include one or more training data items. Each training data item may include damping coefficient values for each bin 405 within the time period and be labeled with an indication of whether the damping coefficient values represent a stable rocket engine 100, an unstable rocket engine 100, or a rocket engine 100 that may become unstable in the future (optionally with an indication of the time period by which the rocket engine 100 may become unstable).

A machine learning model may be trained to be associated with a frequency range and a time period corresponding to a single column of bins 405. The training data set can include one or more training data items, where each training data item includes damping coefficient values for each bin 405 within the frequency range and be labeled with an indication of whether the damping coefficient values represent a stable rocket engine 100, an unstable rocket engine 100, or a rocket engine 100 that may become unstable in the future (optionally with an indication of the time period by which the rocket engine 100 may become unstable).

A machine learning model may be trained to be associated with a frequency range and a time period corresponding to multiple rows of bins 405 and multiple columns of bins 405. The training data set can include one or more training data items, where each training data item includes damping coefficient values for each bin 405 within the frequency range and time period and may be labeled with an indication of whether the damping coefficient values represent a stable rocket engine 100, an unstable rocket engine 100, or a rocket engine 100 that may become unstable in the future (optionally with an indication of the time period by which the rocket engine 100 may become unstable).

In some embodiments, the control system 120 and/or other system may train multiple machine learning models, where each is associated with a different frequency range and/or time period.

Once trained, the trained machine learning model(s) may be stored in memory accessible to the control system 125. Once the rocket engine 100 begins operating, the control system 125 can retrieve the trained machine learning model(s) and periodically provide a portion of or an entire wavelet filter data set 400, 460 as an input to the trained machine learning model(s). Providing a portion of or the entire wavelet filter data set 400, 460 as an input to a trained machine learning model may cause the trained machine learning model to output an indication of whether the rocket engine 100 is stable, unstable, or is about to become unstable (and optionally a time period by which the rocket engine 100 will become unstable).

The portion of the wavelet filter data set 400, 460 input to the trained machine learning model may depend on how the machine learning model was trained. For example, if the machine learning model is associated with a single bin 405, then the control system 125 may provide a damping coefficient corresponding to the single bin 405 as an input to the trained machine learning model. As a result, the control system 125 may retrieve multiple trained machine learning models, one for each bin 405 of interest, and, for each bin 405 of interest, provide a damping coefficient corresponding to the respective bin 405 of interest as an input to the trained machine learning model associated with the respective bin 405.

As another example, if the machine learning model is associated with multiple bins 405, then the control system 125 may provide damping coefficients corresponding to those multiple bins 405 as an input to the trained machine learning model. If the trained machine learning model is not associated with the entire set of bins 405, then the control system 125 may retrieve multiple trained machine learning models, one for each set of bins 405 of interest, and, for each set of bins 405 of interest, provide damping coefficients corresponding to the respective set of bins 405 of interest as an input to the trained machine learning model associated with the respective set of bins 405.

Thus, the control system 125 may receive a single output from a single trained machine learning model or multiple outputs from multiple trained machine learning models during each analysis session. The control system 125 can process the output(s) of the trained machine learning model(s) and cause the rocket engine 100 to throttle down or shut down, can cause the rocket engine 100 to enter a standby state, or can take another remedial action to address rocket engine 100 instability if any output indicates that the rocket engine 100 is or is about to become unstable.

The analysis according to the present disclosure using the wavelet filter data set has various advantages and applications. For example, the analysis may help explain why there is a problem with combustion stability over time of a rocket engine design. The analysis may be done over every single operating point continuously of the rocket engine. The analysis may be done completely in the time domain, which can reduce processing and memory usage of the control system 125 and can reduce control system 125 processing latency. For example, performing the analysis in the frequency domain may involve the control system 125 converting the data from the time domain to the frequency domain, performing the analysis in the frequency domain, and then converting the results of the analysis from the frequency domain back to the time domain. Here, the control system 125 can perform the analysis without having to perform the time domain-to-frequency domain and the frequency domain-to-time domain conversions. By performing fewer operations, the control system 125 can conserve processing and memory resources for other tasks and can produce results of the analysis at a faster rate. Ultimately, producing analysis results at a faster rate can increase the likelihood that rocket engine instability is detected and addressed earlier. The analysis can be used as a training tool for an artificial intelligence (AI) or machine learning (ML) model for predicting imminent instabilities of the rocket engine. The analysis may avoid the need for costly testing and re-design of rocket engines, which can cost in the tens or hundreds of millions of dollars. The analysis may be used to understand the effect on stability of other components in the system, such as when other components are turned on/off or adjusted, such as turbopumps, turbines, generators, valves, etc.

In some embodiments, the systems and methods may be used to directly measure the damping coefficient of an operating combustion chamber by looking at the combustion signal of the system. This may be used to assess damping characteristics both temporally and in frequency, and to relate the damping characteristics back to fundamental instability modes of the system. Further, design features and operating conditions of the combustor may be compared and contrasted by direct measurement. Additionally, real-time monitoring and assessment of damping in the system may be monitored as an actionable test or flight adjustment or shut-off system to save the system from failure, which would be caused if the combustor went unstable. Operation of the rocket engine with combustion chamber or other combustion systems may be adjusted based on the determined damping characteristics using the analyses described herein. For example, the rocket may be throttled down or shut off based on such analyses.

The repeated use of rocket engines either in run duration or reusability puts wear on the system machinery and thus changes the behavior of those systems from beginning-of-life to end-of-life. As the system operation changes due to wear, combustion stability margin or damping can be eroded. Wavelet filtering data of correlated damping coefficient can be examined post-test or post-mission or in real-time using control system 125 to determine how the system could be adjusted for safe operation and/or determine maintenance required for the system to replace components.

### E. Example Damping Assessments Via Regression Analysis of Wavelet Filter Data

FIGS. 4C-4F are example data plots with linear regressions of damping coefficient over time for respective frequency bins from the wavelet filter data sets of FIGS. 4A and 4B. FIGS. 4C-4F show data plots 465, 475, 485, and 495, respectively, for a row of frequency bins that include corresponding frequencies of 6,770 Hz, 5,803 Hz, 5,078 Hz, and 4,513 Hz.

In FIG. 4C, for a row of frequency bins that includes a frequency of 6,770 Hz, the data points 467 are for the low-power unstable firing which are linearized by the line 469, and the data points 471 are for the high-power stable firing which are linearized by the line 473. As shown, there is no change or very little change in damping between the two tests around the first tangential mode of about 6,000-6,500 Hz.

In FIG. 4D, for a row of frequency bins that includes a frequency of 5,803 Hz, the data points 477 are for the low-power unstable firing which are linearized by the line 479, and the data points 481 are for the high-power stable firing which are linearized by the line 483. As shown, the stable test shows a decreased damping at this frequency which is below the first tangential mode.

In FIG. 4E, for a row of frequency bins that includes a frequency of 5,078 Hz, the data points 487 are for the low-power unstable firing which are linearized by the line 489, and the data points 491 are for the high-power stable firing which are linearized by the line 493. As shown, the stable test shows lower damping for the given frequency bin.

In FIG. 4F, for a row of frequency bins that includes a frequency of 4,513 Hz, the data points 496 are for the low-power unstable firing which are linearized by the line 497, and the data points 498 are for the high-power stable firing which are linearized by the line 499. As shown, the stable test has significantly more damping for the given frequency bin.

In some embodiments, the analyses described above may be used to analyze trends in the damping coefficient. As mentioned, rocket engines may be used for long periods of time and/or reused. The damping characteristics of the engines may change over time and/or from mission to mission. A trending damping coefficient may be calculated from the analyses described herein for assessment and/or prediction of engine performance and life.

### F. Example Electronic Block Diagram of System with Combustion System

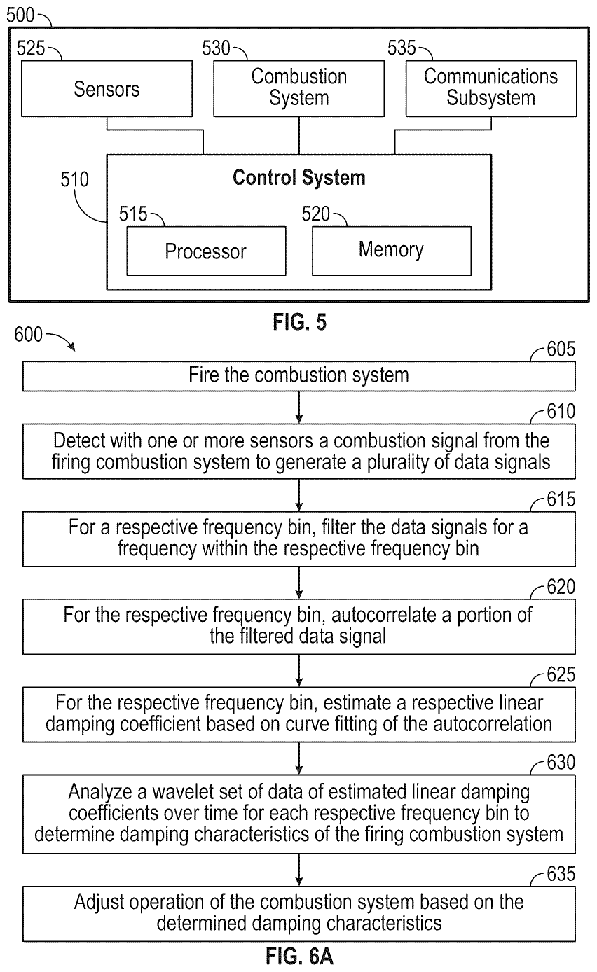

FIG. 5 is a block diagram of an embodiment of a system 500 having a combustion system 530 and that may use any of the methods described herein for damping assessment of the combustion system 530. The system 500 may be used with any of the systems, devices, and methods described herein, such as those shown in FIGS. 1A-4F and 6A-7. For example, the system 500 may represent the rocket engine 100 or the rocket 150, or other system having a combustion system. The combustion system 530 may be a rocket engine or other combustion system.

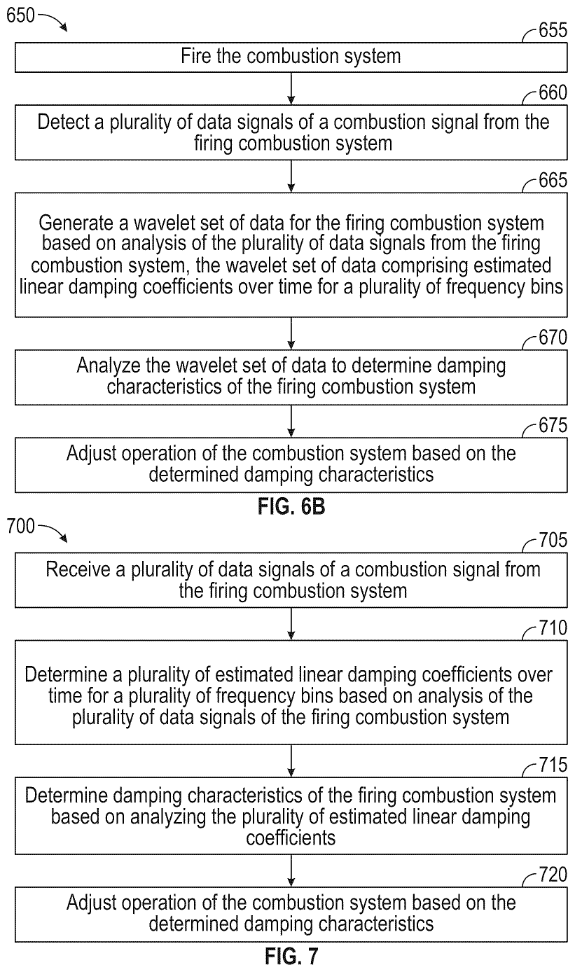

The system 500 includes a control system 510. The control system 510 may be configured to receive and analyze data signals. The control system 510 may analyze the combustion signal as described with respect to FIGS. 2-4F. Based on such analysis, the control system 510 may adjust operation of the system 500 or parts thereof, such as the combustion system 530. The control system 510 may include one or more processors 515 and/or one or more memories 520. The one or more memories 520 may store instructions therein that are executed by the one or more processors 515 to perform various methods according to the present disclosure. The analysis methods described with respect to FIGS. 2-4F may be performed. Any of the methods shown in FIGS. 6A-7 may be performed. The one or more processors 515 and/or one or more memories 520 may be contained on a non-transitory computer readable medium, such as a computer or data storage unit or other electronics. The medium may be configured for use by a rocket or rocket engine. A rocket or rocket engine may contain such medium therein. Other systems besides rocket engines may include the medium.

The system 500 may include one or more sensors 525. The sensors 525 may have the same features or functions as the sensors 130, 170, and vice versa. The sensors 525 may be transducers or accelerometers. The sensors 525 may detect pressure, strain, temperature, flow rate, acoustics, accelerations, and/or other data as discussed herein, for example with respect to FIG. 1A. The sensors 525 may be piezoelectric. The sensors 525 may be flow sensors. The sensors 525 may detect raw signals and generate corresponding data signals. The detected raw signal may cause an electric current or voltage to be generated and/or transmitted by the sensor 525. The data signals may be provided to the control system 510 for analysis.

The system 500 may include one or more subsystems, such as a communications subsystem 535 as shown. The communications subsystem 535 may receive and/or transmit data signals to and/or from the system 500. The communications subsystem 535 may receive or transmit data from or to another system, such as a ground station, a rocket, a satellite, or a spacecraft. The communications subsystem 535 may receive data signals from the control system 510, such as the combustion data signals or resulting analysis of such signals, and transmit the data signals to another system. The communications subsystem 535 may receive data signals from another system and transmit the data signals to the control system 510 for analysis and control of the system 500.

### G. Example Methods of Combustion Noise Analysis to Assess Damping

FIGS. 6A-7 are flow charts showing embodiments of methods for determining damping characteristics of a combustion system based on analysis of the combustion signal and that may be performed by any of the systems described herein. The methods may be performed by the rocket engine 100, the rocket 150, the system 500, or components thereof. The methods may use the data and/or associated analyses shown in and described with respect to FIGS. 2-4F.

FIG. 6A is a flow chart showing an embodiment of a method 600 for determining damping characteristics of an actively firing combustion system. The method 600 begins with block 605 where the combustion system is fired. The combustion system may be starting up, held at constant throttle, have increasing or decreasing throttle, or shutting down. The control system 510, for example the processor 515, may command the combustion system 530 accordingly. Any of the systems shown in and described with respect to FIG. 1A, 1B or 5 may be used.

The method 600 then moves to block 610 where one or more sensors detect the combustion signal from the firing combustion system to generate a plurality of data signals. The sensors may detect changes in pressure, acceleration, or other parameters indicative of the combustion signal. Transducers or accelerometers may be used. The sensors may generate the data signals based on the detected parameters. The sensors may provide a current or voltage to a control system which generates the data signals. The sensors may be used with a rocket engine having a combustion chamber. The control system 510, for example the processor 515, may communicate with the sensors 525 accordingly. Any of the sensors or systems shown in and described with respect to FIG. 1A, 1B or 5 may be used. The data signals shown in and described with respect to FIG. 2 may be generated. Block 610 may be repeated to continuously detect real-time data from the firing combustion system.

The method 600 then moves to block 615 where the data signals are filtered for a frequency within a respective frequency bin of a plurality of frequency bins. A portion of the data signals may be filtered. A band pass filter, wavelet filter, or other filter may be applied. The control system 510, for example the processor 515, may filter the data signals. Any of the filtering processes and/or illustrative data shown in and described with respect to FIG. 3A may be used. Block 615 may be repeated as necessary to provide filtered signals for determining the damping coefficient (see block 625) for multiple frequency bins.

The method 600 then moves to block 620 where a portion of the filtered data signals is autocorrelated. The data signals from the filtered data may be correlated to similar instances of itself as a function of the time between the two instances. The control system 510, for example the processor 515, may autocorrelate the data signals. Any of the autocorrelation or related processes and/or illustrative data shown in and described with respect to FIG. 3B may be used. Block 620 may be repeated as necessary to provide autocorrelation plots for determining the damping coefficient (see block 625) for multiple frequency bins.

The method 600 then moves to block 625 where a respective linear damping coefficient is estimated for the respective frequency bin based on curve fitting of the autocorrelation. The autocorrelation plot or relationship is analyzed, and a representative response plot is identified based on the shape or other characteristics of the autocorrelation plot. The response plot may be for a second-order response. The response plot may be for a generalized force response of a second-order system to non-zero initial conditions, for example as shown in and discussed with respect to FIG. 3D. A governing differential equation, such as equation (1) above, may be used to find a solution, such as equation (2) above. The damping coefficient may be solved for in the solution equation and assigned to the respective frequency bin. The control system 510, for example the processor 515, may determine the damping coefficient. Any of the curve fitting and damping coefficient calculations as shown in and described with respect to FIG. 3D may be used. Block 625 may be repeated as necessary to provide damping coefficients for multiple frequency bins.

The blocks 615, 620, 625 may be performed for each frequency bin of a plurality of frequency bins. Thus, the method 600 may include the blocks 615, 620, 625 being continually calculated. The control system 510, for example the processor 515, may continuously perform blocks 615, 620, 625, either in series or in parallel.

The method 600 then moves to block 630 where a wavelet filter data set of estimated linear damping coefficients over time for each respective frequency bin is analyzed to determine damping characteristics of the firing combustion system. The change in damping coefficient over time for a given firing of the combustion system, or the change in damping coefficient between two different firings of the combustion system or during a transient operation of the combustion system, or the change in damping coefficient for a given frequency level, or the change in frequency level having the lowest and/or highest damping coefficient, or other features of the wavelet filter data set, may be analyzed. The control system 510, for example the processor 515, may analyze the wavelet filter data set. Any of the methods and/or illustrative data shown in and described with respect to FIGS. 4A-4F may be used. Block 630 may be repeated as necessary to update the analysis of the damping characteristics and to continuously provide updated stability assessments.

In some embodiments, the method 600 may then move to block 635 where operation of the combustion system is adjusted based on prior analysis. Operation of the rocket with combustion chamber or other combustion systems may be adjusted based on the determined damping characteristics resulting from the analysis described in block 630. For example, the rocket may be throttled down or shut off if such analysis shows instability is present or imminent. In some embodiments, the block 635 may not be performed. For example, the combustion system may not be adjusted where the determined damping characteristics in block 630 are within acceptable limits.

FIG. 6B is a flow chart showing an embodiment of a method 650 for determining damping characteristics of an actively firing combustion system. The method 650 begins with block 655 where the combustion system is fired. The block 655 may be similar to the block 605 of the method 600 as described above.

The method 650 then moves to block 660 where a plurality of data signals of the combustion signal from the firing combustion system are detected. The block 660 may be similar to the block 610 of the method 600 as described above.

The method 650 then moves to block 665 where a wavelet filter data set is generated for the firing combustion system based on analysis of the plurality of data signals of the combustion signal from the firing combustion system. The wavelet filter data set may comprise estimated linear damping coefficients over time for a plurality of frequency bins. The block 665 may be similar to blocks 615, 620, and/or block 625 of the method 600 described above.

In some embodiments of block 665, methods other than those discussed with respect to blocks 615, 620, and/or block 625 of the method 600 may be used. For example, in block 665, other methods for collecting combustion data signals may be used, such as using different sensors or combinations of sensors, or receiving the data from another system, etc. As further example, in block 665, the wavelet filtering techniques described herein, band pass filtering, various digital signal processing or other filtering techniques, or combinations thereof, may be used for filtering the data signals. As further example, in block 665, other methods for analyzing the data either alternatively or in addition to autocorrelation may be used, such as auto-covariance. As further example, other methods for determining the damping coefficient may be used, such as other types of responses for damped systems.

The method 650 then moves to block 670 where the wavelet filter data set is analyzed to determine damping characteristics of the firing combustion system. The block 670 may be similar to block 630 of the method 600 described above.

In some embodiments, the method 600 may then move to block 675 where operation of the combustion system is adjusted based on prior analysis. The block 675 may be similar to block 635 of the method 600 described above.

FIG. 7 is a flow chart showing an embodiment of a method 700 for determining damping characteristics of an actively firing combustion system. The system 500 may perform the method 700. The method 700 may be performed by one or more processors executing a set of instructions stored by one or more memories. The processor 515 and/or memory 520 of the control system 510 may perform the method 700. A non-transitory computer readable medium, such as a storage device, hard drive or electronic controller, may store the instructions for execution. A rocket or rocket engine may include the non-transitory computer readable medium.

The method 700 begins with block 705 where a plurality of data signals of the combustion signal from the firing combustion system are received. The data signals may be generated in response to a combustion system being started up, held at constant throttle, increased or decreased throttle, or being shut down. The data signals may be received from the sensors 525. The data signals may be received by the control system 510. Any of the systems shown in and described with respect to FIG. 1A, 1B or 5 may be used. The combustion system, such as the rocket engine, may continue firing as block 705 is performed.

The method 700 then moves to block 710 where a plurality of estimated linear damping coefficients are determined over time for a plurality of frequency bins based on analysis of the plurality of data signals of the combustion signal of the firing combustion system. The control system 510, such as the processor 515 and/or memory 520, may perform block 710. Any of the methods shown in and described with respect to FIGS. 2-4F may be used. In some embodiments, any of the blocks of the methods 600 or 650 may be performed. For example, the blocks 615, 620, and/or 625 of the method 600 may be performed. In some embodiments, block 665 of the method 650 may be performed.

The method 700 then moves to block 715 where damping characteristics of the firing combustion system are determined based on analyzing the plurality of estimated linear damping coefficients. The control system 510, such as the processor 515 and/or memory 520, may perform block 710. Any of the methods shown in and described with respect to FIGS. 2-4F may be performed. In some embodiments, any of the blocks of the methods 600 or 650 may be performed. For example, the blocks 615, 620, and/or 625 of the method 600 may be performed. In some embodiments, block 665 of the method 650 may be performed.

In some embodiments, the method 700 may then move to block 720 where operation of the combustion system is adjusted based on prior analysis. The block 720 may be similar to block 635 of the method 600 described above.

### H. Other Embodiments and Terminology

The foregoing description details certain embodiments of damping assessment systems, devices, and methods disclosed herein. It will be appreciated, however, that no matter how detailed the foregoing appears in text, the systems, devices, and methods can be practiced in many ways. The systems and methods according to the present disclosure may be agnostic to the shape, size, type of propellant, engine cycle, or combustion type for a particular rocket or rocket engine. Further, the systems and methods may be used in applications other than rocket engine combustion, including any linear dynamic system having a higher frequency measurement system and background or other signal disturbances. For instance, the systems and methods may be used for building analysis in earthquake assessment, or for buildings, bridges and other structures where natural wind and ground movements provide background or other input to the system and allow for measurement of system damping, for other systems such as cars, boats, airplanes and other vehicles where normal operation can provide the input to measure the systems, for power plants using turbines, for turbojets, or for other systems with continuous energy released at high-power and high pressure.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment can be included with other depicted embodiments in any combination. For example, any of the various systems and methods described herein and/or depicted in the figures may be combined, interchanged or excluded from other embodiments.

It should be noted that the use of particular terminology when describing certain features or aspects of the disclosure should not be taken to imply that the terminology is being re-defined herein to be restricted to including any specific characteristics of the features or aspects of the technology with which that terminology is associated.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The term “comprising” as used herein is synonymous with “including,” “containing,” or “characterized by,” and is inclusive or open-ended and does not exclude additional, unrecited elements or method blocks.

It is noted that some examples above may be described as a process, which is depicted as a flowchart, a flow diagram, a structure diagram, or a block diagram. Although a flowchart may describe the operations as a sequential process, many of the operations can be performed in parallel, or concurrently, and the process can be repeated. In addition, the order of the operations may be rearranged. A process is terminated when its operations are completed. A process may correspond to a method, a function, a procedure, a subroutine, a subprogram, etc. When a process corresponds to a software function, its termination corresponds to a return of the function to the calling function or the main function.

The above description discloses several methods and materials of the present disclosure. This disclosure is susceptible to modifications in the methods and materials, as well as alterations in the fabrication methods and equipment. Such modifications will become apparent to those skilled in the art from a consideration of this disclosure or practice of the embodiments disclosed herein. Consequently, it is not intended that this disclosure be limited to the specific embodiments disclosed herein, but that it covers all modifications and alternatives coming within the true scope and spirit of the disclosure as embodied in the attached claims.

Any references cited herein are incorporated herein by reference in their entirety. To the extent publications and patents or patent applications incorporated by reference contradict the disclosure contained in the specification, the specification is intended to supersede and/or take precedence over any such contradictory material.

What is claimed is:

1. A method of determining damping characteristics of a combustion system, the method comprising:
firing the combustion system;
detecting, with one or more sensors, a combustion signal from the firing combustion system to generate a plurality of data signals,
for each of a respective frequency bin of a plurality of frequency bins:
filtering the plurality of data signals for a frequency within the respective frequency bin,
autocorrelating a portion of the filtered plurality of data signals, and
estimating a respective damping coefficient for the respective frequency bin based on curve fitting of the autocorrelation; and
analyzing a wavelet filter data set to determine damping characteristics of the firing combustion system, the wavelet filter data set comprising estimated damping coefficients for the plurality of frequency bins over time.

2. The method of claim 1, wherein curve fitting comprises solving a generalized characteristic differential equation.

3. The method of claim 1, wherein determining damping characteristics comprises comparing the estimated damping coefficients over time for a range of frequencies that comprises the plurality of frequency bins.

4. The method of claim 1, wherein the plurality of frequency bins comprises one or more frequencies corresponding to an instability of the firing combustion system.

5. The method of claim 1, further comprising detecting the plurality of data signals during a transient operation of the combustion system.

6. The method of claim 5, wherein the transient operation comprises startup, throttling up, throttling down, mixture ratio increase, mixture ratio decrease, feed system propellant temperature increase, feed system propellant temperature decrease, or shutdown of the combustion system.

7. The method of claim 1, wherein the portion of the filtered plurality of data signals is a first portion of the filtered data signals, and wherein the method further comprises:
autocorrelating a second portion of the filtered data signals; and
estimating a respective damping coefficient for the respective frequency bin based on curve fitting of the autocorrelation of the second portion.

8. The method of claim 1, wherein the data signals comprise pressure data signals, vibration data signals, strain data signals, flow rate data signals, temperature data signals, optical data signals, or acoustic data signals.

9. The method of claim 1, wherein the one or more sensors comprises one or more transducers or one or more accelerometers.

10. The method of claim 1, wherein the combustion system is a rocket engine comprising a combustion chamber, and the method further comprises adjusting operation of the rocket engine based on the determined damping characteristics.

11. A method of determining damping characteristics of a combustion system, the method comprising:
firing the combustion system;
detecting a plurality of data signals indicative of a combustion signal from the firing combustion system;
generating a wavelet filter data set for the firing combustion system based on analysis of the plurality of data signals, the wavelet filter data set comprising estimated damping coefficients for a plurality of frequency bins over time; and
analyzing the wavelet filter data set to determine damping characteristics of the firing combustion system.

12. The method of claim 11, wherein analysis of the plurality of data signals comprises autocorrelation of the plurality of data signals.

13. The method of claim 11, wherein generating the wavelet filter data set further comprises:
filtering the plurality of data signals for a frequency within a respective frequency bin of the plurality of frequency bins;
autocorrelating the filtered plurality of data signals; and
estimating a respective damping coefficient for the respective frequency bin based on the autocorrelation.

14. The method of claim 11, wherein the plurality of frequency bins comprises one or more frequencies corresponding to an instability of the firing combustion system.

15. The method of claim 11, further comprising detecting the plurality of data signals during startup, throttling up, throttling down, mixture ratio increase, mixture ratio decrease, feed system propellant temperature increase, feed system propellant temperature decrease, or shutdown of the combustion system.

16. The method of claim 11, wherein the combustion system is a rocket engine comprising a combustion chamber, and the method further comprises adjusting operation of the rocket engine based on the determined damping characteristics.

17. A non-transitory computer readable medium comprising instructions that, when executed by a computing processor, causes a method for determining damping characteristics of an actively firing combustion system, the method comprising:
receiving a plurality of data signals of a combustion signal from the firing combustion system;
determining a plurality of estimated damping coefficients over time for a plurality of frequency bins based on analysis of the plurality of data signals of the combustion signal of the firing combustion system; and
determining damping characteristics of the firing combustion system based on analyzing the plurality of estimated damping coefficients.

18. The non-transitory computer readable medium of claim 17, wherein analysis of the plurality of data signals of the combustion signal of the firing combustion system comprises autocorrelation of the plurality of data signals of the combustion signal.

19. The method of claim 17, wherein the data signals comprise pressure data signals, vibration data signals, strain data signals, flow rate data signals, temperature data signals, optical data signals, or acoustic data signals.

20. The non-transitory computer readable medium of claim 17, wherein the combustion system is a rocket engine comprising a combustion chamber, and where the method further comprises adjusting operation of the rocket engine based on the determined damping characteristics.
